(19) United States
(12) Patent Application Publication
(10) Pub. No.: US 2017/0038914 A1
(43) Pub. Date: Feb. 9, 2017

(54) MEDICAL IMAGE DISPLAY APPARATUS, MEDICAL IMAGE DISPLAY SYSTEM, MEDICAL IMAGE DISPLAY METHOD, AND PROGRAM

(71) Applicant: CANON KABUSHIKI KAISHA, Tokyo (JP)

(72) Inventor: Masami Kawagishi, Kawasaki-shi (JP)

(21) Appl. No.: 15/225,652

(22) Filed: Aug. 1, 2016

(30) Foreign Application Priority Data
Aug. 7, 2015 (JP) 2015-157657

(51) Int. Cl. G06F 3/0481; G06T 11/60

(52) U.S. Cl. CPC G06F 3/0481; G06T 11/60

(57) ABSTRACT

A medical image display apparatus displays a medical image in an image display area and selects a first partial area and a second partial area from among a plurality of partial areas included in the image display area in response to an operation input. Based on the arrangement of a plurality of medical images included in the first partial area, the medical image display apparatus determines the arrangement of these medical images in the second partial area and displays these medical images in the second partial area in the determined arrangement in response to an operation input.

### BACKGROUND

Field

Aspects of the present invention generally relate to a medical image display apparatus, a medical image display system, a medical image display method, and a program.

Description of the Related Art

In recent years, various medical images have been used for diagnoses. In such a diagnosis, an operator operates a medical image display apparatus to, for example, display a medical image on a display unit, change display contents to display contents suitable for the diagnosis, and change the arrangement of medical images.

Japanese Patent Laid-Open No. 2010-200936 discloses a technique for generating an image arrangement check box showing a medical image display area and changing the arrangement of displayed medical images in response to an operation performed on the image arrangement check box. In order to change the display positions of a plurality of medical images displayed in a certain arrangement, an operator needs to change the respective display contents of these medical images.

### SUMMARY

According to some embodiments of the present invention, a medical image display apparatus includes a display control unit configured to display a medical image in an image display area and a selection unit configured to select a first partial area and a second partial area from among a plurality of partial areas included in the image display area in response to an operation input. The display control unit changes display contents in the second partial area in response to the operation input to display a plurality of medical images included in the first partial area based on an arrangement of the medical images in the first partial area.

Further features of aspects of the present invention will become apparent from the following description of exemplary embodiments with reference to the attached drawings.

### BRIEF DESCRIPTION OF THE DRAWINGS

FIG. 1 is a diagram illustrating the functional configuration of a system including a medical image display apparatus according to an embodiment of the present invention.

FIG. 2 is a diagram illustrating the configuration of a medical image display apparatus according to an embodiment.

FIG. 3 is a flowchart illustrating a process performed by a medical image display apparatus according to an embodiment.

FIGS. 4A and 4B are diagrams illustrating display examples on a display unit realized by a medical image display apparatus according to an embodiment.

FIGS. 5A and 5B are diagrams illustrating display examples on a display unit realized by a medical image display apparatus according to an embodiment.

FIGS. 6A and 6B are diagrams illustrating display examples on a display unit realized by a medical image display apparatus according to an embodiment.

FIGS. 7A and 7B are diagrams illustrating display examples on a display unit realized by a medical image display apparatus according to an embodiment.

### DESCRIPTION OF THE EMBODIMENTS

Embodiments of the present invention will be described below with reference to the accompanying drawings.

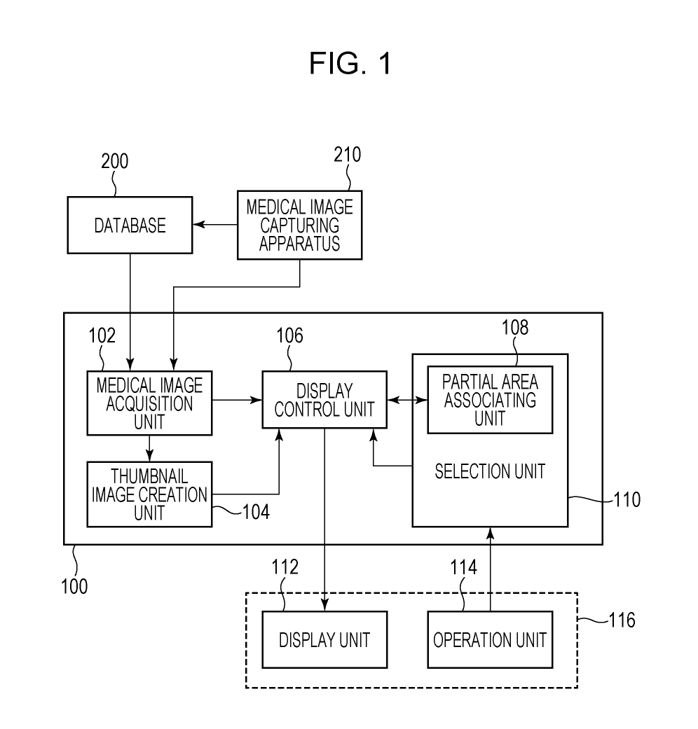

FIG. 1 is a diagram illustrating the functional configuration of a system including a medical image display apparatus (hereinafter referred to as a display apparatus) 100 according to an embodiment of the present invention. Blocks correspond to respective functions of the system. The system includes, for example, a database 200, a medical image capturing apparatus (hereinafter referred to as an image capturing apparatus) 210, and a display unit 112 in addition to the display apparatus 100. Components in the system are communicably connected to one another.

The database 200 stores medical image data captured by the image capturing apparatus 210. An image obtained by performing image processing upon an image captured by the image capturing apparatus 210 for the purpose of acquiring an image suitable for a diagnosis is also regarded as a medical image. The image capturing apparatus 210 is, for example, a computed tomography (CT) apparatus, a magnetic resonance imaging (MRI) apparatus, or a digital radiography (DR) apparatus for capturing a two-dimensional radiological image. The image capturing apparatus 210 outputs data of a captured medical image to the database 200 via a communication device (not illustrated).

The database 200 stores the data of the medical image. The database 200 is, for example, a picture archiving and communication system (PACS) sever. The database 200 outputs stored medical image data to the display apparatus 100 via a communication device (not illustrated) in response to, for example, a user's operation input.

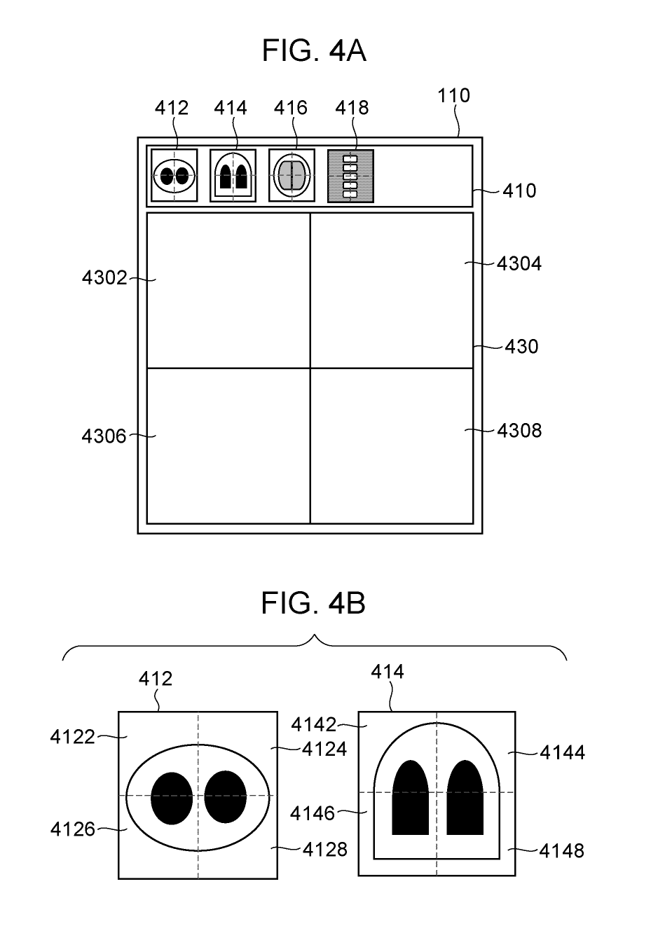

The display apparatus 100 displays a medical image in a medical image display area 430 (see FIG. 4) and performs display change processing upon a medical image in response to a user's operation input. The display apparatus 100 includes a medical image acquisition unit (hereinafter referred to as an acquisition unit) 102, a thumbnail image creation unit (hereinafter referred to as a creation unit) 104, a display control unit 106, a partial area associating unit (hereinafter referred to as an associating unit) 108, and a selection unit 110. Each functional component in the display apparatus 100 corresponds to a program for realizing a corresponding function. These programs are stored in a magnetic disk 1003 and are executed by a central processing unit (CPU) 1001. Alternatively, each functional component in the display apparatus 100 corresponds to a field-programmable gate array (FPGA) including a program for realizing a corresponding function. Each functional component in the display apparatus 100 will be described below.

The medical image acquisition unit 102 acquires medical image data from the database 200 via a communication device (not illustrated) in response to a user's operation input. The acquisition unit 102 can acquire medical image data from the image capturing apparatus 210 and perform image processing upon the medical image as appropriate in the display apparatus 100. The acquisition unit 102 outputs the medical image data acquired from the database 200 or the image capturing apparatus 210 to the creation unit 104 and the display control unit 106.

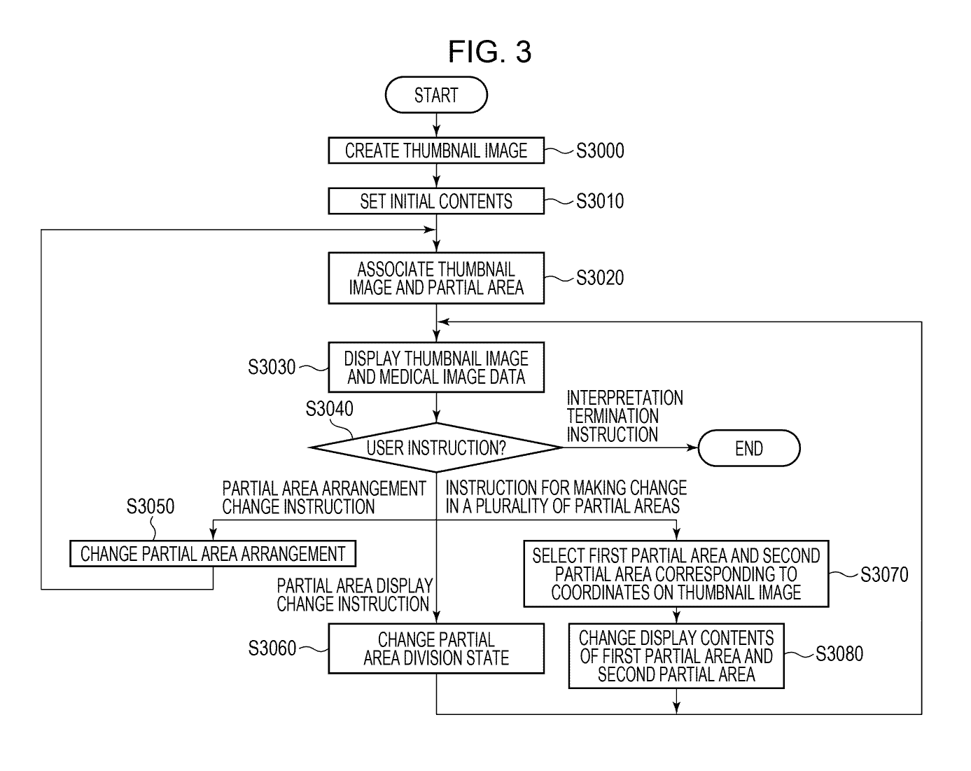

The creation unit 104 receives the medical image data from the acquisition unit 102 and creates a thumbnail image of the medical image based on the received data. A thumbnail image is a reduced image used to represent information about a corresponding medical image when the list of pieces of information about a plurality of medical images is displayed. A thumbnail image creation method performed by the creation unit 104 will be described in detail later with reference to FIGS. 3 to 7B. The creation unit 104 outputs data of the created thumbnail image to the display control unit 106.

The display control unit 106 controls contents to be displayed on the display unit 112 based on the medical image data acquired from the acquisition unit 102 and the data of a thumbnail image acquired from the creation unit 104. The display control unit 106 divides a medical image display area where a medical image is displayed into a plurality of partial areas and performs display control in these partial areas. The display control unit 106 outputs information about the contents of each partial area and information about the display contents of each partial area to the associating unit 108. The display control unit 106 can further divide a partial area and perform control processing to display a medical image in the divided partial area.

The display control unit 106 controls contents to be displayed on the display unit 112 based on pieces of information input from the associating unit 108 and the selection unit 110. The display control unit 106 controls contents to be displayed on the display unit 112 based on the display contents of a first partial area and a second partial area selected by the selection unit 110. This display control will be described in detail later with reference to FIGS. 3 to 7B.

The selection unit 110 includes the associating unit 108. The associating unit 108 acquires information about the correspondence between a thumbnail image displayed by the display control unit 106 and a partial area in a medical image display area (hereinafter referred to as correspondence information). An associating method will be described later with reference to FIGS. 3 to 7B. The selection unit 110 selects the first partial area and the second partial area based on a user's operation input performed via the operation unit 114 and the correspondence information acquired by the associating unit 108. This selection processing will be described later with reference to FIGS. 3 to 7B.

The display unit 112 displays a screen controlled by the display control unit 106, and is, for example, a monitor.

The operation unit 114 inputs a user's operation into the display apparatus 100, and is, for example, a mouse. In another example, the display unit 112 and the operation unit 114 are integrated into a display operation unit 116. The display operation unit 116 is, for example, a touch-screen monitor.

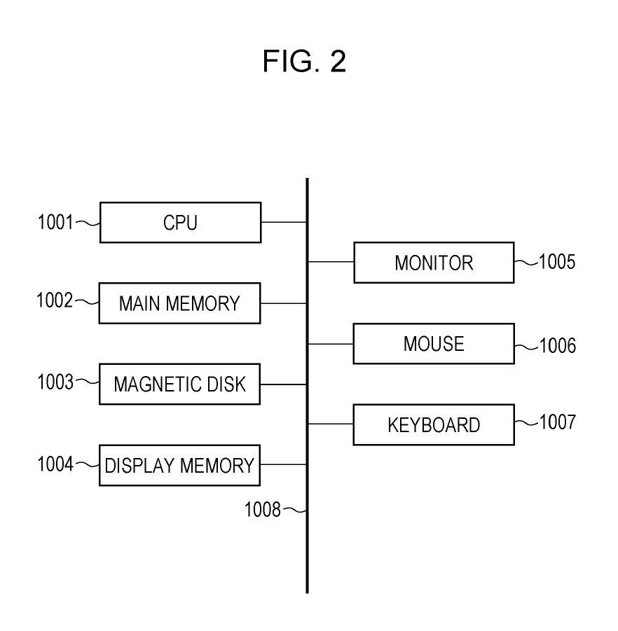

FIG. 2 is a diagram illustrating the configuration of the display apparatus 100. The display apparatus 100 includes the CPU 1001, a main memory 1002, the magnetic disk 1003, a display memory 1004, a monitor 1005, a mouse 1006, and a keyboard 1007.

The CPU 1001 integrally controls processing of the display apparatus 100. The CPU 1001 reads a program that realizes each functional component illustrated in FIG. 1 into the main memory 1002 from the magnetic disk 1003 and executes the program.

The main memory 1002 is a memory accessible from the CPU 1001, and is, for example, a Random Access Memory (RAM) or a Read-Only Memory (ROM). The main memory 1002 stores a program that the CPU 1001 executes and provides a work area where the CPU 1001 executes a program.

The magnetic disk 1003 stores an operating system, a device drive for a peripheral device, and various application software programs including a program that realizes each functional component illustrated in FIG. 1. The magnetic disk 1003 is, for example, a hard disk drive (HDD) or a solid state drive (SSD).

The display memory 1004 temporarily stores data to be displayed on the display unit 112. Contents to be displayed on the display unit 112 are controlled by the display control unit 106 and are output to the display unit 112 via the display memory 1004.

The monitor 1005 displays an image, text, etc., based on an input from the display memory 1004. The monitor 1005 is an example of the display unit 112. The monitor 1005 is, for example, a cathode-ray tube (CRT) monitor or a liquid crystal display (LCD) monitor.

The mouse 1006 and the keyboard 1007 receive a user's operation input and output the contents of the operation input to each unit in the display apparatus 100. That is, a user inputs desired information into the display apparatus 100 using the mouse 1006 and the keyboard 1007. The mouse 1006 and the keyboard 1007 are examples of the operation unit 114.

Components illustrated in FIG. 2 are communicably connected to one another via a common bus 1008.

In a case where the display apparatus 100 is a terminal including a touch-screen monitor, the display apparatus 100 does not necessarily have to include the mouse 1006 and the keyboard 1007. A user can input desired information into the display apparatus 100 by operating a keyboard displayed on the display unit of a touch-screen monitor using a finger or a stylus pen.

Next, a process performed by the display apparatus 100 will be described with reference to a flowchart in FIG. 3. In the following process, the CPU 1001 performs each piece of processing unless otherwise noted. In an embodiment of the present invention, the process from the acquisition of a medical image to the display of the medical image using the display apparatus 100 to the end of the process is referred to as interpretation.

In response to a user's operation input, the display apparatus 100 acquires a medical image to be displayed on the display apparatus 100 from the database 200 based on patient information and examination order information. The patient information and the examination order information are managed by a hospital information system (HIS) (not illustrated) or a radiology information system (RIS) (not illustrated). The display apparatus 100 acquires information from an HIS (not illustrated) or an RIS (not illustrated) and causes the display control unit 106 to display the information on the display unit 112.

A user can select a medical image to be displayed on the display unit 112 based on pieces of information displayed on the display unit 112, such as information about a patient, information about an examination of the patient, and information about a series of image capturing in the examination. The acquisition unit 102 acquires the selected medical image from the database 200. At that time, in addition to a medical image captured at the time of an examination of a patient, the acquisition unit 102 can acquire, for example, information about a finding of the patient and display the acquired information on the display unit 112.

The creation unit 104 creates a thumbnail image of the medical image acquired by the acquisition unit 102. A thumbnail image can be any image enabling a user to visually check the overview of the original medical image. In a case where the medical image is a two-dimensional image, a thumbnail image is created by reducing the medical image to a two-dimensional image of a predetermined size, for example, 64×64 pixels. In a case where a medical image is a three-dimensional image formed of a plurality of two-dimensional images, a thumbnail image is created by selecting one of these two-dimensional images and reducing the selected two-dimensional image to an image of a predetermined size.

For example, a chest X-ray CT image formed of a plurality of cross-sectional (axial) images at different positions in a craniocaudal direction is a three-dimensional image. A two-dimensional image acquired by reducing one of the axial images in the CT image closest to the head is set as a thumbnail image. A user can set a cross-sectional image at any position on any axis as a thumbnail image of the CT image by performing setting or an operation input. In this embodiment, it is assumed that the acquisition unit 102 acquires a chest X-ray CT image in response to a user's operation input and the creation unit 104 creates the thumbnail images of an axial image, a sagittal image, and a coronal image in response to a user's operation.

Turning to FIG. 3, in step S3000, a thumbnail image is created. In step S3010, initial contents are set for a medical image display area where a medical image is displayed. The display control unit 106 sets the display contents of partial areas in the medical image display area to be displayed on the display unit 112 under the instruction of a user. Alternatively, the display control unit 106 can read display contents set in advance and set the display contents. Information about display contents includes information about the position of each partial area in a medical image display area (hereinafter referred to as partial area information). The information about display contents further includes information about a medical image displayed on each partial area (hereinafter referred to as display image information). The information about display contents also includes information about a partial area division state (hereinafter referred to as division information).

The display control unit 106 reflects the set display contents in display performed by the display unit 112 and stores the display contents in the main memory 1002. In this embodiment, initial contents are set in which a medical image display area is formed of two partial areas in an X direction and two partial areas in a Y direction, that is, four partial areas. No medical image is displayed in each of the partial areas and each of the partial areas is not divided. As a result, an image illustrated in FIG. 4A is displayed on the display unit 112. The medical image display area 430 is formed of four partial areas, partial areas 4302, 4304, 4306, and 4308.

In step S3020, a thumbnail image and each partial area in the medical image display area are associated with each other. The associating unit 108 acquires correspondence information that is information about the correspondence between a position on each thumbnail image created in step S3000 and a position in one of a plurality of partial areas. The correspondence information is stored in the main memory 1002.

More specifically, each thumbnail image is includes the arrangement of areas that is the same as the arrangement of partial areas in the medical image display area, and coordinates in an area on a thumbnail image and a partial area in the medical image display area that have the same location are associated with each other. For example, based on the initial contents set in step S3010, coordinates of each point on each thumbnail image are allocated to one of four areas, two in the X direction and two in the Y direction.

Coordinates included in the upper right area are associated with the upper right partial area. FIG. 4B illustrates exemplary thumbnail images created in step S3000. The medical image display area 430 is formed of four partial areas as illustrated in FIG. 4A. Accordingly, a thumbnail image 412 includes the arrangement of four areas 4122, 4124, 4126, and 4128 that is the same as the arrangement of the partial areas.

Coordinates in the area 4122 are associated with the partial area 4302. Coordinates in the area 4124 are associated with the partial area 4304. Coordinates in the area 4126 are associated with the partial area 4306. Coordinates in the area 4128 are associated with the partial area 4308. Coordinates of each point in the other thumbnail images are associated with a corresponding partial area and correspondence information is stored in the main memory 1002. For example, a thumbnail image 414 includes four areas 4142, 4144, 4146, and 4148, and coordinates in the area 4142 are associated with the partial area 4302.

In step S3030, thumbnail images and a medical image are displayed. The display control unit 106 displays the thumbnail images created in step S3000 in a thumbnail image display area 410 and displays a medical image in the medical image display area in response to a user's operation input. The thumbnail images 412, 414, 416, and 418 are thumbnail images created in step S3000.

In step S3040, in response to a user's operation input, the type of an instruction is determined. In a case where an interpretation termination instruction is received from a user, the process ends. A menu or an icon that is a user interface used to make an interpretation termination instruction is set in advance and is displayed on the display unit 112. When a user performs an operation input via this user interface, it is determined that an interpretation termination instruction has been made. In a case where the operation of the display apparatus 100 is terminated or a program for realizing the functions of the display apparatus 100 is terminated, the process also ends.

In step S3040, in a case where an instruction for changing display contents is made, the process proceeds to step S3050 or S3060. The determination of whether the instruction for changing display contents has been made is performed based on a user's operation input performed via a user interface displayed on the display unit 112 by the display control unit 106.

In step S3040, in a case where it is determined that a partial area arrangement change instruction has been made, the process proceeds to step S3050. The partial area arrangement change means, for example, the change in the number of partial areas in the medical image display area or the change in the size of each partial area, that is, the change of the partial area information. The partial area arrangement change is performed by a user's operation input performed upon a menu screen for setting of display contents.

In another example, in order to change a partial area arrangement, a user performs an operation input by moving, with the operation unit 114, a frame that is a boundary between the medical image display area and each partial area displayed on the display unit 112 or a frame that is a boundary between areas into which a partial area is divided. In a case where the arrangement of the partial areas is changed, the process proceeds to step S3020 in which a thumbnail image and each of the partial areas are associated based on the changed arrangement of the partial areas. Correspondence information acquired in step S3020 is stored in the main memory 1002. The process proceeds to step S3030 in which a screen reflecting the change is displayed on the display unit 112.

The size ratio among partial areas and the size ratio among corresponding areas in a thumbnail image do not necessarily have to be the same. For example, it is assumed that the size ratio of the partial areas 4302, 4304, 4306, and 4308 is changed from 1:1:1:1 to 1:3:3:9. In this case, the size ratio of corresponding areas in a thumbnail image can also be changed to 1:3:3:9 or cannot be changed from 1:1:1:1 based on the idea that the size ratio merely represents the number of times of division of the medical image display area. For user friendliness, the size ratio of partial areas can be fixed.

If it is determined in step S3040 that a partial area display change instruction has been made, the process proceeds to step S3060. The partial area display change means the change of an image displayed in a partial area or the change of a partial area division state, that is, the change of display image information or the change of division information. In a case where contents displayed in a partial area are changed, the process proceeds to step S3030 in which the display control unit 106 displays a screen reflecting the change on the display unit 112.

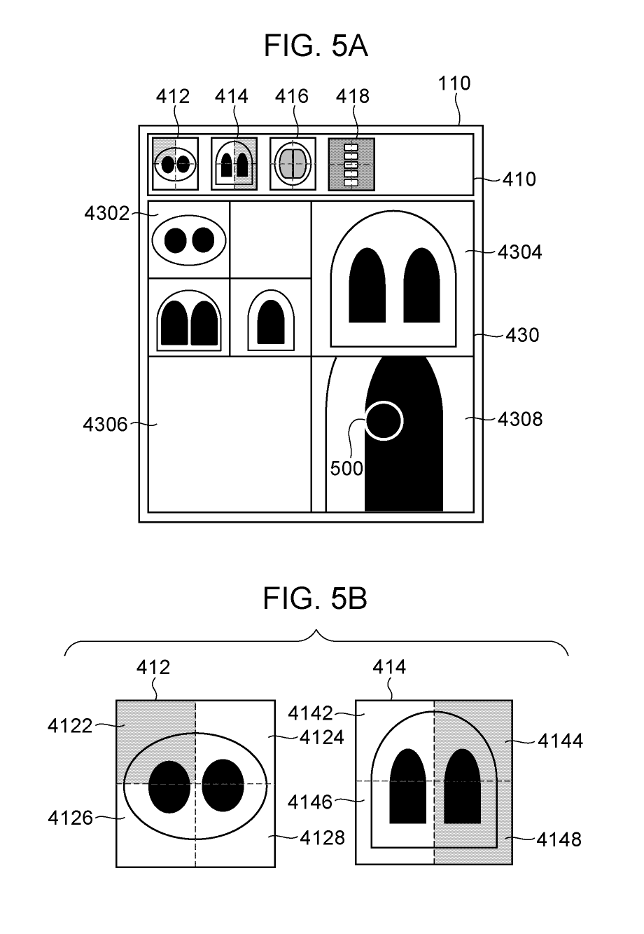

The processing of step S3060 will be described with reference to FIGS. 5A and 5B. First, the change of an image displayed in a partial area will be described. Referring to FIG. 4A, no medical image is displayed in the partial area 4302. For example, when the thumbnail image 412 is dragged and dropped into the partial area 4302 using the mouse 1006, the display control unit 106 displays a medical image corresponding to the thumbnail image 412 in the partial area 4302 in response to this operation input.

In another example, when the area 4122 on the thumbnail image 412 is clicked, the display control unit 106 displays a medical image corresponding to the thumbnail image 412 in the partial area 4302 in response to this operation input. Coordinates in the area 4122 on the thumbnail image 412 have been associated with the partial area 4302 in step S3020. Based on coordinates at which a click has been made and correspondence information, the display control unit 106 displays a medical image corresponding to the thumbnail image 412 in the partial area 4302. Next, the change of a partial area division state will be described. For example, a partial area division state can be changed by a user's operation input performed upon a menu screen for division information setting.

The change of an image displayed in a partial area and the change of a partial area division state are sometimes performed at the same time. For example, these changes are performed at the same time in a case where tomographic images in three directions orthogonal to one another are displayed (hereinafter referred to as MPR display) in the partial area 4302 as medical images corresponding to the thumbnail image 412. For example, the MPR display can be set by displaying a menu screen (not illustrated) used to set the MPR display after displaying a medical image corresponding to the thumbnail image 412 in the partial area 4302 by the above-described operation.

When the MPR display is set, the acquisition unit 102 acquires, from the database 200, tomographic images of the medical image corresponding to the thumbnail image 412, which are acquired in three directions orthogonal to one another. Alternatively, in a case where a medical image is formed of a plurality of axial tomographic images, the display apparatus 100 can generate sections (a coronal tomographic image and a sagittal tomographic image) orthogonal to each other. In a case where a medical image is formed of a plurality of coronal tomographic images or a plurality of sagittal tomographic images, the display apparatus 100 can also generate sections orthogonal to each other.

The acquisition unit 102 outputs the medical image acquired from the database 200 to the display control unit 106. The display control unit 106 displays the tomographic images in three directions orthogonal to one another in the partial area 4302. As a result, the partial area 4302 is further divided into four areas, and the image displayed on the partial area is changed. Setting can be made in advance so that in a case where an operation input is performed to display an MPR-displayable image in the medical image display area, the acquisition unit 102 automatically acquires the medical image and the display control unit 106 displays three images. In this case, when the area 4122 on the thumbnail image 412 is clicked as described above, images including the medical image corresponding to the thumbnail image 412 are MPR-displayed in the partial area 4302.

In the partial areas 4304 and 4308 illustrated in FIG. 5A, medical images corresponding to the thumbnail image 414 are similarly displayed. In the partial area 4308, a part of the medical image displayed in the partial area 4304 is enlarged and displayed. The enlarged display can be performed by the display control unit 106 displaying a medical image corresponding to the thumbnail image 414 in the partial area 4308 by the above-described operation and then displaying a menu screen for the enlarged display.

Alternatively, a medical image can be enlarged or reduced with respect to any point on the medical image by the button operation and movement operation of the mouse 1006. A medical image corresponding to the thumbnail image 414 displayed in the partial area 4304 can be enlarged and displayed in a partial area designated by a user, for example, the partial area 4308 without changing the display contents of the partial area 4304.

The medical images corresponding to the thumbnail images 412 and 414 are displayed in the medical image display area 430. The display control unit 106 distinguishes an area on a thumbnail image corresponding to a partial area where a medical image corresponding to the thumbnail image is displayed from the other areas based on correspondence information at the time of display. For example, as illustrated in FIG. 5B, the area 4122 on the thumbnail image 412 is highlighted in a color different from the color of the areas 4124, 4126, and 4128. Since the medical images corresponding to the thumbnail image 414 are displayed in the partial areas 4304 and 4308, the areas 4144 and 4148 are highlighted. In order to distinguish a certain area on a thumbnail image from the other areas at the time of display, another method can be employed. For example, a frame can be used to highlight an area.

The change of a display form such as MPR display and enlarged display can be performed by a user's operation input. For example, it is possible to make an annotation by superimposing a figure such as a circle or a square or a text string on an image. Furthermore, it is possible to display reduced image or to change the gradation level of an image at the time of display of the image. In a case where a medical image is a three-dimensional image formed of a plurality of two-dimensional images, it is possible to change a two-dimensional image displayed on a partial area by changing a slice position in data of the three-dimensional image.

In this embodiment, in a case where a display image is changed, the changed display image is displayed under display conditions set in advance. For example, it is assumed that, in a partial area designated by a drag-and-drop operation input, another medical image has already been displayed. In this case, the display control unit 106 does not employ display conditions for the image displayed before the operation input and displays a medical image for which a display instruction has been made by the operation input under display conditions set in advance. Even if the same medical image is displayed before and after the operation input, the medical image is displayed under display conditions set in advance. The setting of display conditions is performed in advance by a user.

Alternatively, in a case where medical image data includes a digital imaging and communications in medicine (DICOM) format, display conditions can be automatically set based on information about a DICOM header. In a case where a three-dimensional image formed of a plurality of two-dimensional images is displayed, the display control unit 106 displays one of the two-dimensional images in a medical image display area. For example, in a case where a chest X-ray CT image formed of a plurality of axial tomographic images acquired at different positions in the craniocaudal direction is displayed, the display control unit 106 displays one of the axial tomographic images acquired at a position nearest to the head in a medical image display area.

In a case where display contents are changed as described above, changed display contents are stored in a memory (not illustrated) and the process proceeds to step S3030.

In a case where it is determined in step S3040 that an instruction for making a change in a plurality of partial areas has been made, the process proceeds to step S3070. An instruction for making a change in a plurality of partial areas is made by selecting a plurality of partial areas at the time of an operation input. For example, a first partial area and a second partial area on a thumbnail image are selected at the time of an operation input. The selection unit 110 selects a first partial area and a second partial area in response to a user's operation input.

For example, the selection unit 110 selects the first partial area and the second partial area in response to a drag-and-drop operation input performed on a single thumbnail image. The selection unit 110 selects the first partial area and the second partial area corresponding to coordinates on a thumbnail image on which a user's operation input has been performed, that is, positional information based on the correspondence information stored in a memory (not illustrated) in step S3020.

The selection unit 110 selects a partial area corresponding to the start point of the drag and drop on a thumbnail image, that is, a point at which a user has pressed a button (not illustrated) of the mouse 1006, as the first partial area. The selection unit 110 similarly selects a partial area corresponding to the end point of the drag and drop on the thumbnail image, that is, a point at which the button of the mouse 1006 is released, as the second partial area.

In a case where the first partial area and the second partial area are the same area, the process returns to step S3030. Alternatively, as previously described, in a partial area corresponding to information about a position on a thumbnail image where an operation input has been performed, a medical image corresponding to the thumbnail image can be displayed. That is, an image displayed in a partial area corresponding to information about a position on a thumbnail image where an operation input has been performed can be changed by the processing of step S3060.

In step S3080, the display control unit 106 changes the display contents of the second partial area based on the display contents of the first partial area selected in step S3070.

In this embodiment, as an exemplary case where the display contents of the second partial area are changed, the display control unit 106 displays a medical image included in the first partial area in the second partial area under display conditions of the first partial area. At that time, the display contents of the first partial area are not changed. That is, the medical image included in the first partial area is copied in the second partial area.

More specifically, the display contents of the first partial area is read from a memory (not illustrated) and is stored in the memory (not illustrated) as the display contents of the second partial area. After the completion of the storage, the process proceeds to step S3030. In a case where no image is displayed in the first partial area, no processing is performed and the process proceeds to step S3030.

That is, the display control unit 106 displays a medical image included in the first partial area selected by the selection unit 110 in the second partial area. At that time, the display control unit 106 determines the arrangement of medical images in the second partial area based on the arrangement of a plurality of medical images included in the first partial area. From a different viewpoint, the selection unit 110 selects the first partial area and the second partial area based on information about a position where an operation input has been performed on a thumbnail image. Subsequently, the display control unit 106 changes contents displayed in the second partial area so that the medical image included in the first partial area selected by the selection unit 110 is displayed in the second partial area.

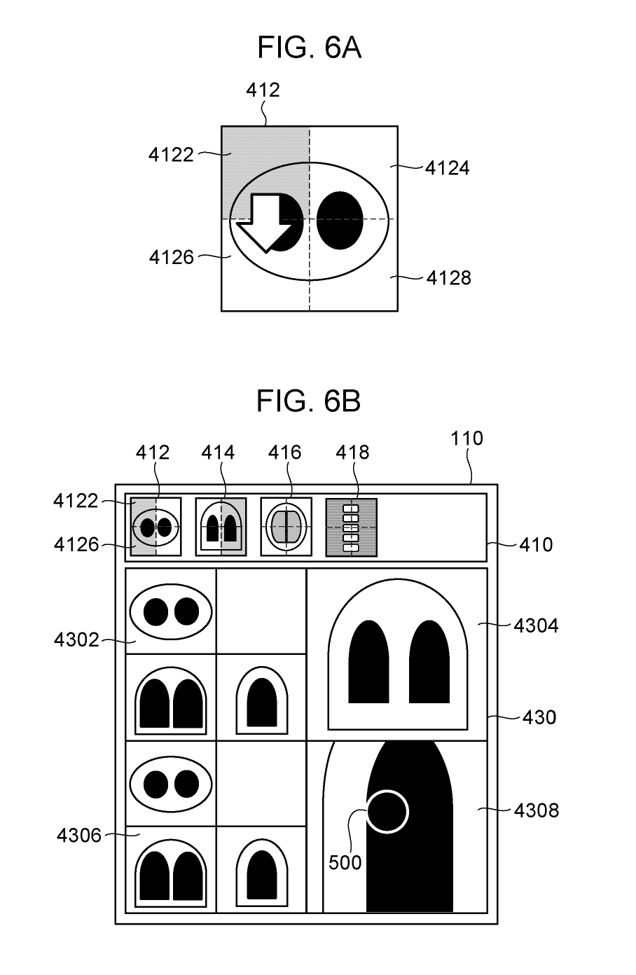

The processing of step S3070 and the processing of step S3080 will be described with reference to FIGS. 6A and 6B. In the state illustrated in FIG. 5A, the first partial area and the second partial area are selected by the processing of step S3070. Subsequently, the processing of step S3080 is performed and the display contents of the display unit 112 illustrated in FIGS. 6A and 6B are obtained in step S3030.

FIG. 6A is a schematic diagram illustrating a user's drag-and-drop operation input between the areas 4122 and 4126 on the thumbnail image 412 in step S3070. The selection unit 110 selects the partial area 4302 corresponding to positional information of the area 4122 that is a start point as the first partial area. The selection unit 110 similarly selects the partial area 4306 corresponding to the positional information of the area 4126 that is an end point as the second partial area. In this case, the selected partial areas 4302 and 4306 are not the same area and there is an image displayed in the partial area 4302. Accordingly, the processing of step S3080 is performed.

The display control unit 106 reads the display contents of the partial area 4302 from a memory (not illustrated) and stores the read display contents as the display contents of the partial area 4306. As illustrated in FIG. 5A, in the display contents of the partial area 4302, the MPR display of medical image data corresponding to the thumbnail image 412 is performed. Accordingly, the display contents of the partial area 4306 are set to contents in which medical image data corresponding to the thumbnail image 412 is displayed using the MPR display form. That is, the display control unit 106 displays in the partial area 4306 contents displayed in the partial area 4302 under the same display state as illustrated in FIG. 6B. A medical image corresponding to the thumbnail image 412 is displayed in the partial areas 4302 and 4306. Accordingly, the display control unit 106 highlights the areas 4122 and 4126 corresponding to the partial areas 4302 and 4306 in the thumbnail image 412.

According to this embodiment, the display apparatus 100 can set the display contents of the second partial area to the display contents of the first partial area based on the display contents of the selected first partial area and the selected second partial area. As a result, a user can display in a desired display area an image displayed in a certain partial area while keeping the display contents of the partial area. This reduces the burden on the user of setting display contents.

The display unit 112 in the display apparatus 100 is sometimes formed of a plurality of monitors. In this case, a medical image display area is set in a wide region on a plurality of monitors. In order to select or move each of medical images displayed in the medical image display area, a user performs an operation input over the wide region. In this embodiment, based on information about a position on a thumbnail image, a medical image displayed in a certain partial area can be displayed in another partial area. Accordingly, even in a case where a medical image is displayed over a wide region, it is possible to perform a desired operation input in a small region. This can reduce the burden on a user.

In another exemplary case where the first partial area and the second partial area are selected, the selection of the first partial area and the second partial area may not be performed on a single thumbnail image. For example, a drag-and-drop operation input is performed while setting the thumbnail image 414 and the thumbnail image 412 as a start point and an end point, respectively. The selection unit 110 selects the partial area 4304 in which a medical image corresponding to the thumbnail image 414 is displayed as a first partial area. In addition, the selection unit 110 selects the partial area 4302 in which a medical image corresponding to the thumbnail image 412 is displayed as a second partial area.

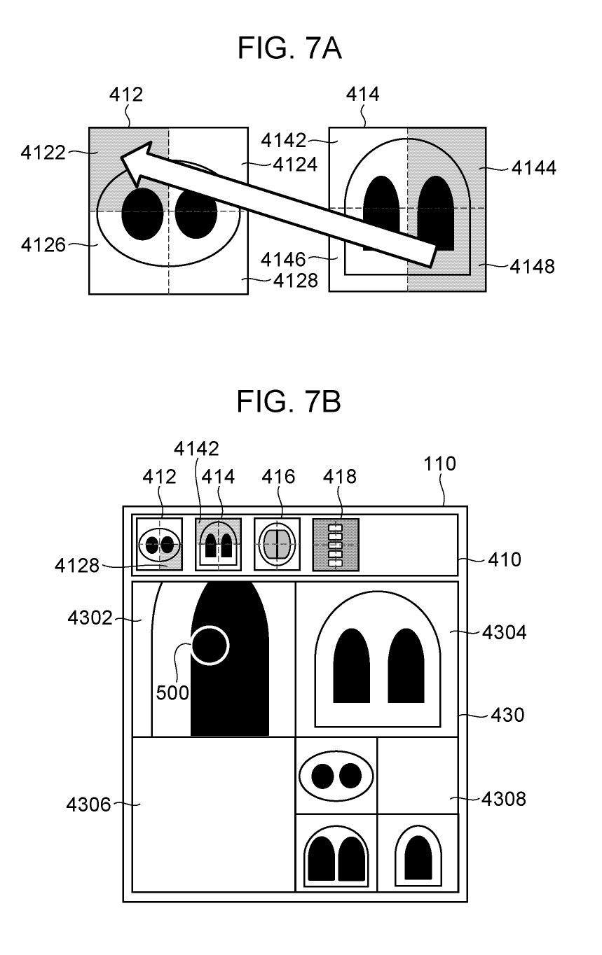

The selection unit 110 can select a partial area corresponding to an area highlighted by the display control unit 106 on which an operation input has been performed. As illustrated in FIG. 6B, a medical image corresponding to the thumbnail image 414 is displayed in the partial areas 4304 and 4308. At that time, since the start point of an operation input is present on the area 4148 as illustrated in FIG. 7A, the selection unit 110 selects the partial area 4308 as the first partial area. Since the end point of the operation input is present on the area 4122, the selection unit 110 selects the partial area 4302 as the second partial area.

In another exemplary case where the selection of the first partial area and the second partial area is performed, the selection does not necessarily have to be performed on a thumbnail image. For example, in response to an operation input performed by designating a certain partial area and pressing the Ctrl key and the C key of a keyboard at the same time, the selection unit 110 selects the partial area where the operation input has been performed as the first partial area. In response to an operation input performed by designating another partial area and pressing the Ctrl key and the V key of a keyboard at the same time, the selection unit 110 selects the partial area where the operation input has been performed as the second partial area.

In another exemplary case, the selection unit 110 selects the first partial area and the second partial area in response to an operation input performed on a partial area. For example, it is assumed that a user performs a drag-and-drop operation input while setting a start point on the partial area 4302 and setting an end point on the partial area 4306 in the state illustrated in FIG. 5A. The selection unit 110 selects the partial area 4302 as the first partial area and selects the partial area 4306 as the second partial area. A plurality of medical images included in the partial area 4302 are copied and displayed in the partial area 4306. A user can copy a plurality of medical images in a partial area and display them in another partial area by a single drag-and-drop operation.

In another exemplary case where the display contents of the first partial area and the second partial area are changed, no image is displayed in the first partial area after the display contents of the first partial area have been set as the display contents of the second partial area. That is, the display of a medical image displayed in the first partial area is cleared until an operation input is performed. That is, the display control unit 106 moves the medical image included in the first partial area to the second partial area and displays the medical image in the second partial area.

In still yet another exemplary case where the display contents of the first partial area and the second partial area are changed, the display contents of the first partial area and the display contents of the second partial area are exchanged. That is, the display control unit 106 exchanges a medical image included in the first partial area and a medical image included in the second partial area, and displays them. An exemplary case where medical images are exchanged and displayed will be described with reference to FIGS. 7A and 7B. The state of the display unit 112 before this processing is the state illustrated in FIG. 5A.

FIG. 7A is a schematic diagram illustrating a user's drag-and-drop operation from the area 4148 on the thumbnail image 414 to the area 4122 on the thumbnail image 412. In this case, the selection unit 110 selects the partial area 4308 corresponding to the area 4148 that is a start point as the first partial area. The selection unit 110 similarly selects the partial area 4302 corresponding to the area 4122 that is an end point as the second partial area. The display control unit 106 exchanges the display contents of the first partial area and the display contents of the second partial area and displays them in respective partial areas.

In the display contents of the partial area 4308 before the operation input is performed, a display image is a medical image corresponding to the thumbnail image 414, a display form is enlarged display, and an annotation 500 is made. An annotation is a figure or a text string superimposed on an image. In response to the operation input, a medical image included in the partial area 4308 is displayed in the partial area 4302 that is the second partial area without changing the display contents of the partial area 4308. In the display contents of the partial area 4302 before the operation input is performed, a display image is a medical image corresponding to the thumbnail image 412 and a display form is the MPR display. In response to the operation input, a medical image included in the partial area 4302 is displayed in the partial area 4308 that is the first partial area without changing the display contents of the partial area 4302. Since partial areas where medical images corresponding to thumbnail images are displayed have been changed, the display control unit 106 also changes highlights on the thumbnail images. As a result, contents displayed on the display unit 112 are as illustrated in FIG. 7B.

The selection of the first partial area and the second partial area do not necessarily have to be performed by a drag-and-drop operation. For example, in response to a click operation input performed at a certain position on a single thumbnail image, the selection unit 110 selects a partial area corresponding to information about the position at which the click operation input has been performed as the first partial area. In response to a click operation input performed at another position on the same thumbnail image, the selection unit 110 selects a partial area corresponding to information about the position at which the click operation input has been performed as the second partial area. As a result, it is possible to move a medical image displayed in the first partial area to the second partial area and display it.

In the above-described case where the selection unit 110 selects the first partial area and the second partial area, on a thumbnail image corresponding to an operation target medical image, a user performs an operation input in an area corresponding to the position of a displayed partial area. Here, a method of causing the selection unit 110 to select the first partial area and the second partial area in a case where a user has not performed an appropriate operation input, which can be set in advance by a user, will be described with reference to FIG. 5A.

As illustrated in FIG. 5A, a medical image corresponding to the thumbnail image 412 is displayed in the partial area 4302. It is assumed that a user performs an operation input to move an image displayed in the partial area 4302 to the partial area 4304 and display the image in the partial area 4304. In this case, starting from a position on the area 4122 corresponding to the partial area 4302, an operation input has to be performed. However, the user can perform an operation input starting from a position on the area 4126 corresponding to the partial area 4306 by operation mistake. A user can set a method of causing the selection unit 110 to select the first partial area and the second partial area in such a case where an inappropriate operation input is performed.

For example, the selection unit 110 selects a partial area where a medical image corresponding to a thumbnail image on which an operation input has been performed is displayed as a first partial area. Subsequently, the selection unit 110 determines movement of an image between partial areas desired by a user based on an operation input by the user and selects a partial area where the desired movement can be realized as a second partial area. It is assumed that a user performs an operation input while setting the area 4126 as a start point and setting the area 4128 as an end point. That is, the movement of an image between partial areas desired by the user is the movement from a partial area to a right-side partial area.

Since a medical image corresponding to the thumbnail image 412 is displayed in the partial area 4302, the movement to the partial area 4304 on the right side of the partial area 4302 can be realized. It is assumed that the user performs an operation input while setting the area 4126 as a start point and setting the area 4122 as an end point. That is, the movement of an image between partial areas desired by the user is the movement from a partial area to an upper side partial area. Since it is impossible to move the medical image displayed in the partial area 4302 to an upper side partial area, the selection unit 110 selects no partial area. Accordingly, processing for changing contents displayed in a partial area such as the movement or copying of contents is not performed. In another exemplary case, the selection unit 110 can select no partial area in response to an inappropriate operation input. This can prevent the occurrence of a user's operation mistake. Such exception handling can be set in advance by a user, and is not limited to the above-described exemplary case.

The display apparatus 100 can be realized by a tablet terminal having a touch-screen monitor as the display operation unit 116. The display control unit 106 displays a medical image in an image display area of the display operation unit 116. For example, the display control unit 106 functions as an acquisition unit for acquiring a position where an instruction has been made by an operation input performed via an object such as a stylus pen or a user's finger. The display operation unit 116 determines a position on, for example, a touch-screen monitor with which an object makes contact as a designated position.

In a case where a designated position is a certain position on a thumbnail image and does not move during a predetermined period, the selection unit 110 selects a partial area corresponding to the designated position as the first partial area. Subsequently, it is assumed that the display control unit 106, which is an acquisition unit, acquires information about the movement of the designated position. The display operation unit 116 determines that a user's operation input has ended when the object is out of contact with the touch-screen monitor. The selection unit 110 selects a second partial area based on a designated position acquired immediately before the user's input operation ends. A method of determining a designated position is not limited to a method of determining a contact between a touch-screen monitor and an object. The selection of the first partial area and the second partial area is performed using any embodiment described above.

The display apparatus 100 can be realized by, for example, a server apparatus (not illustrated). The display control unit 106 functions as a display output unit for outputting data displayable on a display unit in a display terminal (not illustrated) having a function of displaying data transmitted from a server apparatus (not illustrated). For example, the display control unit 106 in a server apparatus (not illustrated) outputs hyper text markup language (HTML) data. A display terminal (not illustrated) provided with a known browser system interprets HTML data and displays the data on the display unit 112. The selection unit 110 in a server apparatus (not illustrated) accepts an operation input performed via a display terminal (not illustrated) and performs processing for selecting a first partial area and a second partial area.

The above-described embodiments can be realized as a medical image display system including a plurality of apparatuses. Each functional component in the display apparatus 100 illustrated in FIG. 1 can be included in any one of a plurality of apparatuses in the system. For example, a server apparatus (not illustrated) and a display terminal (not illustrated) are used to form the system. The display terminal (not illustrated) includes the selection unit 110. The display terminal (not illustrated) is, for example, a tablet terminal and includes the display operation unit 116. The server apparatus (not illustrated) includes the acquisition unit 102, the creation unit 104, the display control unit 106, and the associating unit 108. As previously described, in response to a user's operation performed via the display operation unit 116, the selection unit 110 in the display terminal (not illustrated) selects a first partial area and a second partial area. The display terminal (not illustrated) outputs the selected partial areas to the server apparatus (not illustrated). The server apparatus (not illustrated) outputs a result of processing performed by the display control unit 106 in response to a user's operation to the display terminal (not illustrated).

As previously described, by selecting an area including a certain arrangement of a plurality of medical images and an area in which a user wants to display these medical images by a user's operation, it is possible to determine an arrangement of the medical images in a new display area based on the certain arrangement and display the medical images. This can reduce the burden on the user.

The display apparatus 100 according to an embodiment of the present invention can be realized as a single apparatus. Alternatively, the above-described process can be performed by the combination of apparatuses each including a plurality of information processing devices and being communicable with each other. Both cases are included in an embodiment of the present invention. The above-described process can be a common server apparatus or a group of servers. A medical image display apparatus and a plurality of apparatuses included in a medical image display system do not necessarily have to be present in the same facility or the same country on the condition that they can communicate with one another at a predetermined communication rate.

In an embodiment of the present invention, a software program that realizes the functions of the above-described embodiments is supplied to a system or an apparatus, and a computer of the system or apparatus reads and executes program codes of the supplied software program.

Accordingly, the program codes installed on the computer to realize a process according to an embodiment of the present invention are therefore also an embodiment of the present invention. Furthermore, the functions of the above-described embodiments can also be realized when an operating system (OS) operating on a computer executes a part of or the whole of actual processing based on instructions included in a program read by the computer.

The above-described embodiments of the present invention can be employed in combination.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-157657, filed Aug. 7, 2015, which is hereby incorporated by reference herein in its entirety.

What is claimed is:

1. A medical image display apparatus comprising:
a display control unit configured to display a medical image in an image display area; and
a selection unit configured to select a first partial area and a second partial area from among a plurality of partial areas included in the image display area in response to an operation input,
wherein the display control unit changes display contents in the second partial area in response to the operation input to display a plurality of medical images included in the first partial area based on an arrangement of the medical images in the first partial area.

2. The medical image display apparatus according to claim 1, wherein the display control unit changes a division state of the second partial area to a same division state as the first partial area.

3. The medical image display apparatus according to claim 1, wherein the display control unit displays a thumbnail image corresponding to the medical image in a thumbnail image display area.

4. The medical image display apparatus according to claim 3, wherein the selection unit associates positional information about a position on the thumbnail image and partial area information about an arrangement of the partial areas with each other and selects the first partial area and the second partial area based on positional information about a position on the thumbnail image at which an operation input has been performed.

5. The medical image display apparatus according to claim 4, wherein the selection unit selects a partial area corresponding to positional information about a start point of the operation input performed on the thumbnail image as the first partial area and selects a partial area corresponding to positional information about an end point of the operation input performed on the thumbnail image as the second partial area.

6. The medical image display apparatus according to claim 5, wherein, in a case where a medical image corresponding to the thumbnail image is included in a partial area corresponding to positional information about the start point of an operation input performed on the thumbnail image, the selection unit selects the partial area as the first partial area.

7. The medical image display apparatus according to claim 1, wherein, in a case where the display control unit changes display contents in the second partial area, the display control unit does not change display contents in the first partial area.

8. The medical image display apparatus according to claim 1, wherein, in a case where the display control unit changes display contents in the second partial area, the display control unit changes display contents in the first partial area to clear display of a medical image displayed in the first partial area until the operation input is performed.

9. The medical image display apparatus according to claim 1, wherein, in a case where the display control unit changes display contents in the second partial area, the display control unit changes display contents in the first partial area to display in the first partial area a medical image displayed in the second partial area until the operation input is performed.

10. The medical image display apparatus according to claim 1, further comprising an operation unit configured to perform the operation input,
wherein the selection unit selects the first partial area based on a position designated by the operation unit when an operation is performed on the operation unit, and selects the second partial area based on a position designated by the operation unit when an operation is performed on the operation unit.

11. The medical image display apparatus according to claim 1, further comprising an acquisition unit configured to acquire information about a designated position designated by an operation input on an image displayed by the display control unit,
wherein the selection unit selects the first partial area based on a designated position acquired by the acquisition unit in a case where the designated position does not move during a predetermined period, and selects the second partial area based on a designated position acquired by the acquisition unit immediately before the operation input ends.

12. A medical image display apparatus comprising:
a display control unit configured to display a medical image in an image display area; and
a selection unit configured to select a first partial area and a second partial area from among a plurality of partial areas included in the image display area in response to an operation input,
wherein the display control unit changes a division state of the second partial area to a same division state as the first partial area, and changes display contents in the second partial area so that a medical image included in the first partial area is displayed in the second partial area.

13. A medical image display apparatus comprising:
a display control unit configured to display a medical image in an image display area and display a thumbnail image corresponding to the medical image in a thumbnail image display area; and
a selection unit configured to select a first partial area and a second partial area from among a plurality of partial areas included in the image display area based on positional information about a position on the thumbnail image at which an operation input has been performed;
wherein the display control unit changes display contents in the second partial area to display a medical image included in the first partial area.

14. A medical image display system comprising:
a display control unit configured to display a medical image in an image display area; and
a selection unit configured to select a first partial area and a second partial area from among a plurality of partial areas included in the image display area in response to an operation input,
wherein the display control unit changes display contents in the second partial area in response to the operation input to display in the second partial area a plurality of medical images included in the first partial area based on an arrangement of the medical images in the first partial area.

15. A medical image display method comprising the steps of:
displaying a medical image in an image display area; and
selecting a first partial area and a second partial area from among a plurality of partial areas included in the image display area in response to an operation input,
wherein display contents in the second partial area are changed in response to the operation input to display a plurality of medical images included in the first partial area based on an arrangement of the medical images in the first partial area.

16. A medical image display method comprising the steps of:
displaying a medical image in an image display area; and
selecting a first partial area and a second partial area from among a plurality of partial areas included in the image display area in response to an operation input,
wherein a division state of the second partial area is changed to a same division state as the first partial area, and display contents in the second partial area are changed so that a medical image included in the first partial area is displayed in the second partial area.

17. A medical image display method comprising the steps of:
displaying a medical image in an image display area and displaying a thumbnail image corresponding to the medical image in a thumbnail image display area;
selecting a first partial area and a second partial area from among a plurality of partial areas included in the image display area based on positional information about a position on the thumbnail image at which an operation input has been performed; and
changing display contents in the second partial area to display in the second partial area a medical image included in the first partial area.
